(19) United States
(12) Patent Application Publication
(10) Pub. No.: US 2018/0284789 A1
(43) Pub. Date: Oct. 4, 2018

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Hiroshi Oguro, Wako-shi (JP); Katsuya Yashiro, Wako-shi (JP); Toshiyuki Kaji, Wako-shi (JP); Toru Kokaki, Wako-shi (JP); Masanori Takeda, Wako-shi (JP)

(21) Appl. No.: 15/914,109

(22) Filed: Mar. 7, 2018

(30) Foreign Application Priority Data
Mar. 30, 2017 (JP) 2017-066596

(51) Int. Cl. G05D 1/02; G05D 1/00; B60W 50/00; B60W 30/09

(52) U.S. Cl. CPC G05D 1/0214; G05D 1/0088; B60W 2550/10; B60W 30/09; G05D 2201/0212; B60W 50/0097

(57) ABSTRACT

A vehicle control system includes a detector that detects an obstacle present in a space around a vehicle and separated from a road surface, and an action plan generating part that estimates at least one of a size and a type of the obstacle detected by the detector, predicts a behavior of the obstacle on the basis of the estimated result, and generates a danger avoidance action plan of the vehicle on the basis of the predicted result of the behavior of the obstacle.

### CROSS-REFERENCE TO RELATED APPLICATION

Priority is claimed on Japanese Patent Application No. 2017-066596, filed Mar. 30, 2017, the content of which is incorporated herein by reference.

### BACKGROUND OF THE INVENTION

### Field of the Invention

The present invention relates to a vehicle control system, a vehicle control method, and a vehicle control program.

### Description of Related Art

Recently, research on a technique of automatically controlling at least one of acceleration and steering of a vehicle (hereinafter, referred to as “automated driving”) such that the vehicle travels along a path to a destination has been carried out. In addition, a falling object detecting device for a vehicle configured to detect a falling object that falls from a preceding vehicle traveling in front of the own vehicle has been proposed (for example, see Japanese Unexamined Patent Application, First Publication No. 2010-108371).

### SUMMARY OF THE INVENTION

Incidentally, a vehicle is expected to further improve safety.

An aspect of the present invention provides a vehicle control system, a vehicle control method, and a vehicle control program that are capable of further improving safety.

A vehicle control system according to the present invention employs the following configurations.

(1) A vehicle control system according to an aspect of the present invention includes a detector that detects an obstacle present in a space around a vehicle and separated from a road surface; and an action plan generating part that estimates at least one of a size and a type of the obstacle detected by the detector, predicts a behavior of the obstacle on the basis of the estimated result, and generates a danger avoidance action plan of the vehicle on the basis of the predicted result of the behavior of the obstacle.

(2) In the aspect of (1), the danger avoidance action plan may include a control instruction related to at least one of an acceleration, a deceleration and steering of the vehicle, a warning with respect to an occupant in the vehicle, and an operation of a pretensioner of a seat belt of the vehicle.

(3) In the aspect of (1) or (2), the action plan generating part may determine a necessity of obstacle avoidance on the basis of the predicted result of the behavior of the obstacle and information related to a future behavior of the vehicle, and generate the danger avoidance action plan when it is determined that the obstacle avoidance is necessary.

(4) In the aspect of any one of (1) to (3), the action plan generating part may determine a necessity of obstacle avoidance on the basis of the estimated result of at least one of the size and the type of the obstacle, and generate the danger avoidance action plan when it is determined that the obstacle avoidance is necessary.

(5) In the aspect of (4), the action plan generating part may determine that the obstacle avoidance is not necessary when it is estimated that the type of the obstacle is a preset type.

(6) In the aspect of any one of (1) to (5), the action plan generating part may generate a danger avoidance action plan in order to avoid a contact between the obstacle and a preset portion of the vehicle when it is determined that a contact between the obstacle and the vehicle cannot be avoided on the basis of the predicted result of the behavior of the obstacle.

(7) In the aspect of (6), the vehicle may include a first portion and a second portion, the second portion being a portion in which a degree of influence upon contact with the obstacle is smaller than the first portion, and the action plan generating part may generate a danger avoidance action plan that brings the second portion into contact with the obstacle instead of the first portion when it is determined that the obstacle will come into contact with the first portion on the basis of the predicted result of the behavior of the obstacle.

(8) In the aspect of any one of (1) to (7), the detector may be able to detect an obstacle that is falling, and the action plan generating part may predict a falling behavior of the obstacle on the basis of the estimated result of at least one of the size and the type of the obstacle, and generate a danger avoidance action plan of the vehicle on the basis of the predicted result of the falling behavior of the obstacle.

(9) A vehicle control system according to another aspect of the present invention includes a detector that detects an obstacle present in a space around a vehicle and separated from a road surface; and an action plan generating part that estimates a type of the obstacle detected by the detector and determines whether a necessity of obstacle avoidance on the basis of the estimated result of the type of the obstacle.

(10) A vehicle control method according to an aspect of the present invention allows an onboard computer to detect an obstacle present in a space around a vehicle and separated from a road surface; and estimate at least one of a size and a type of the obstacle, predict a behavior of the obstacle on the basis of the estimated result, and generate a danger avoidance action plan of the vehicle on the basis of the predicted result of the behavior of the obstacle.

(11) A vehicle control program according to an aspect of the present invention allows an onboard computer to detect an obstacle present in a space around a vehicle and separated from a road surface; and estimate at least one of a size and a type of the obstacle, predict a behavior of the obstacle on the basis of the estimated result, and generate a danger avoidance action plan of the vehicle on the basis of the predicted result of the behavior of the obstacle.

According to the aspects of (1), (10) and (11), since the behavior of the obstacle is predicted on the basis of the estimated result of at least one of the size and the type of the obstacle and the danger avoidance action plan of the vehicle is generated on the basis of the predicted result of the behavior of the obstacle, the probability of contact between the obstacle and the vehicle can be more securely reduced. Accordingly, further improvement of safety can be achieved.

According to the aspect of (2), since the control instruction related to at least one of the acceleration, the deceleration, and the steering of the vehicle, the alarm with respect to the occupant in the vehicle, and the operation of the pretensioner of the seat belt of the vehicle is executed, it is possible to avoid the obstacle, give awareness to the occupant, or more securely protect the occupant using a seat belt. Accordingly, further improvement of safety can be achieved.

According to the aspect of (3), since a necessity of obstacle avoidance is determined on the basis of the predicted result of the behavior of the obstacle and information related to a future behavior of the vehicle, a necessity of obstacle avoidance can be more accurately determined. Accordingly, an unnecessary danger avoidance action can be suppressed, and further improvement of safety can be achieved.

According to the aspects of (4) and (5), a necessity of obstacle avoidance is determined on the basis of the estimated result of at least one of the size and the type of the obstacle. Accordingly, for example, when the obstacle is small or the obstacle is flexible, an unnecessary danger avoidance action can be suppressed, and further improvement of safety can be achieved.

According to the aspects of (6) and (7), since the danger avoidance action plan in order to avoid a contact between the obstacle and the preset area in the vehicle is generated, contact damage received by the vehicle when the vehicle comes into contact with the obstacle can be reduced. Accordingly, further improvement of safety can be achieved.

According to the aspect of (8), since a falling behavior of the obstacle is predicted and the danger avoidance action plan of the vehicle is generated on the basis of the predicted result of the falling behavior of the obstacle, it is possible to more securely reduce the probability of contact between the falling object and the vehicle. Accordingly, further improvement of safety can be achieved.

### BRIEF DESCRIPTION OF THE DRAWINGS

FIG. 1 is a configuration view of a vehicle system according to an embodiment.

FIG. 2 is a view showing an aspect in which a relative position and an attitude of an own vehicle with respect to a traveling lane are recognized by an own vehicle position recognition part.

FIG. 3 is a view showing an aspect in which a target trajectory is generated on the basis of a recommended lane.

FIG. 4 is a configuration view showing a function of a vehicle system when an obstacle is encountered.

FIG. 5 is a view showing an example of a falling object, which is an obstacle.

FIG. 6 is a plan view showing an example of area setting by an area setting part.

FIG. 7 is a plan view showing another example of area setting by the area setting part.

FIG. 8 is a flowchart showing an example of a processing flow of the vehicle system.

### DETAILED DESCRIPTION OF THE INVENTION

Hereinafter, an embodiment of a vehicle control system, a vehicle control method, and a vehicle control program of the present invention will be described with reference to the accompanying drawings. Further, “on the basis of XX” disclosed herein means that something is on the basis of at least XX, and also includes the case in which something is on the basis of another element in addition to XX. In addition, “on the basis of XX” is not limited to the case in which XX is directly used, and also includes the case in which computation or processing with respect to XX is performed. “XX” is an arbitrary element (for example, an arbitrary indicator or a physical quantity and other information).

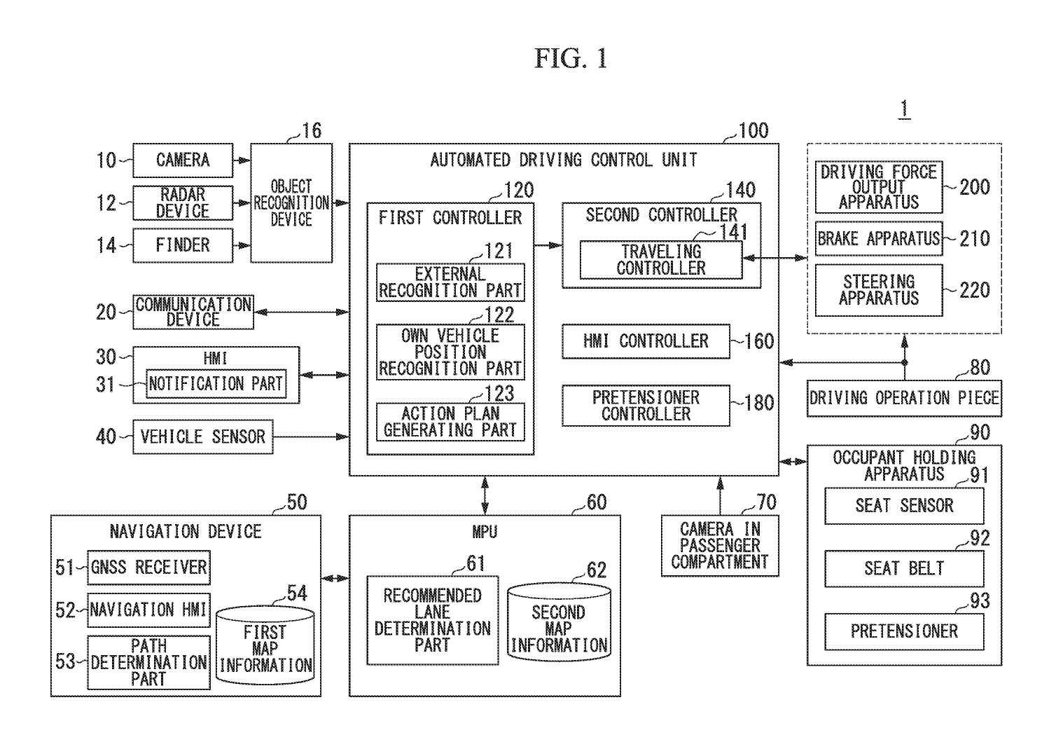

FIG. 1 is a configuration view of a vehicle system 1 according to the embodiment. A vehicle in which the vehicle system 1 is mounted is, for example, a two-wheeled, three-wheeled, or four-wheeled vehicle or the like, and a driving source thereof is an internal combustion engine such as a diesel engine, a gasoline engine, or the like, an electric motor, or a combination thereof. The electric motor is operated using an output generated by a generator connected to the internal combustion engine, or discharged power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a micro-processing unit (MPU) 60, a camera 70 in a passenger compartment, a driving operator 80, an occupant holding apparatus 90, an automated driving control unit 100, a driving force output apparatus 200, a brake apparatus 210, and a steering apparatus 220.

These devices and instruments are connected to each other by a multiplex communication line such as a controller area network (CAN) communication line or the like, a serial communication line, a wireless communication network, or the like. Further, the configuration shown in FIG. 1 is merely an example, and a part of the configuration may be omitted or other configurational components may be added thereto.

The “vehicle control system” includes, for example, the camera 10, the radar device 12, the finder 14, the object recognition device 16, the communication device 20, the HMI 30, the vehicle sensor 40, the navigation device 50, the MPU 60, the camera 70 in a passenger compartment, the occupant holding apparatus 90, and the automated driving control unit 100.

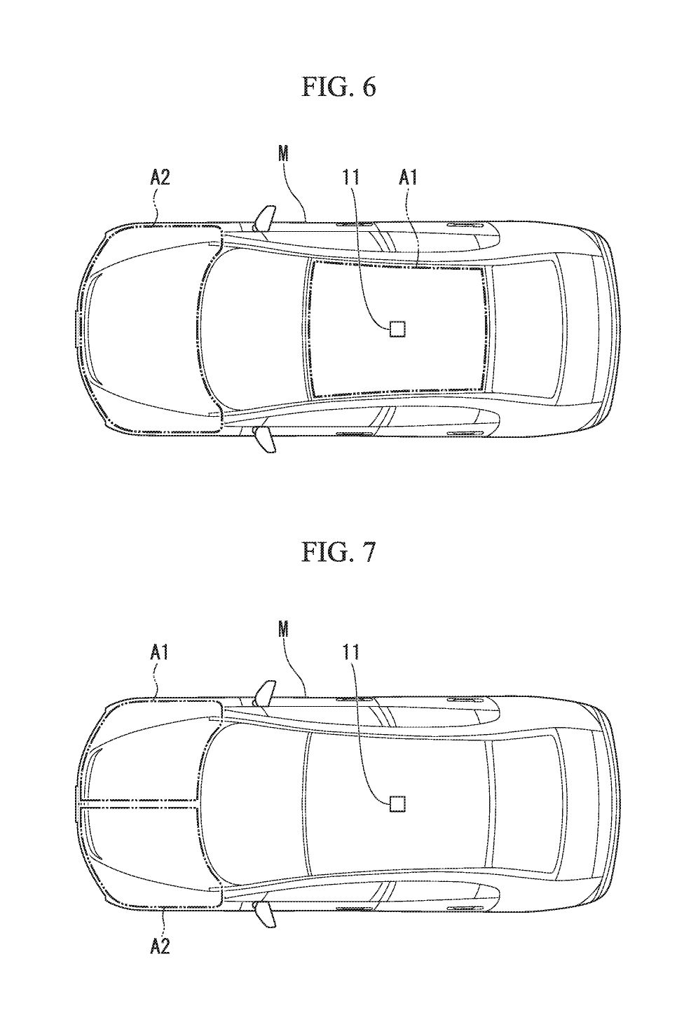

The camera 10 is a digital camera using a solid-state image sensing device such as a charge coupled device (CCD), a complementary metal oxide semiconductor (CMOS), or the like. One or a plurality of cameras 10 are attached to arbitrary places on the vehicle on which the vehicle control system is mounted (hereinafter, referred to as an own vehicle M). When an area in front of the vehicle is imaged, the camera 10 is attached to an upper section of a front windshield, a back surface of a rearview mirror, or the like. The camera 10, for example, periodically repeats imaging of the surroundings of the own vehicle M. The camera 10 may be a stereo camera. In the embodiment, the camera 10 may include a camera 11 (see FIG. 6) installed on an upper surface or the like of a roof of the own vehicle M and configured to image an area above the own vehicle M.

The radar device 12 radiates radio waves such as millimeter waters to the surroundings of the own vehicle M and detects radio waves reflected by an object (reflected waves) to detect at least a position (a distance and an azimuth) of the object. One or a plurality of radar devices 12 are attached to arbitrary places of the own vehicle M. The radar device 12 may detect a position and a speed of an object using a frequency modulated continuous wave (FM-CW) method.

The finder 14 is Light Detection and Ranging, or Laser Imaging Detection and Ranging (LIDAR) that measures scattered light with respect to radiated light and detects a distance to a target. One or a plurality of finders 14 are attached to arbitrary places of the own vehicle M.

The object recognition device 16 performs sensor fusion processing with respect to the detected result using some or all of the camera 10, the radar device 12 and the finder 14, and recognizes a position, a type, a speed, and the like, of an object. The object recognition device 16 outputs the recognized result to the automated driving control unit 100.

The communication device 20 communicates with another vehicle that is present around the own vehicle M (an example of a neighboring vehicle) or communicates with various types of server devices via a radio base station using, for example, a cellular network, a Wi-Fi network, Bluetooth (registered trade mark), Dedicated Short Range Communication (DSRC), or the like.

The HMI 30 presents various types of information to an occupant in the own vehicle M and receives an input operation from the occupant. The HMI 30 includes various types of display devices, speakers, buzzers, touch panels, switches, keys, or the like. The HMI 30 of the embodiment includes a notification part 31. The notification part 31 is a warning notification part configured to inform the occupant in the own vehicle M of a fact that, for example, an obstacle present around the own vehicle M may come into contact with the own vehicle M. The notification part 31 is constituted by, for example, at least one of the speaker, the buzzer or the display device. However, the configuration of the notification part 31 is not limited to the above-mentioned example.

The vehicle sensor 40 includes a vehicle speed sensor configured to detect a speed of the own vehicle M, an acceleration sensor configured to detect an acceleration, a yaw rate sensor configured to detect an angular speed around a vertical axis, an azimuth sensor configured to detect a direction of the own vehicle M, and the like. The vehicle sensor 40 outputs the detected information (the speed, acceleration, angular speed, azimuth, and the like) to the automated driving control unit 100.

The navigation device 50 includes, for example, a Global Navigation Satellite System (GNSS) receiver 51, a navigation HMI 52 and a path determination part 53, and stores first map information 54 in a storage device such as a Hard Disk Drive (HDD), a flash memory, or the like. The GNSS receiver 51 specifies a position of the own vehicle M on the basis of a signal received from a GNSS satellite. The position of the own vehicle M may be specified or complemented by using an Inertial Navigation System (INS) using the output of the vehicle sensor 40. The navigation HMI 52 includes a display device, a speaker, a touch panel, a key, and the like. The navigation HMI 52 may be partially or entirely the same as the above-mentioned HMI 30. The path determination part 53 determines, for example, a route from the position of the own vehicle M identified by the GNSS receiver 51 (or an input arbitrary position) to a destination input by an occupant by using the navigation HMI 52 with reference to the first map information 54. The first map information 54 is, for example, information that expresses a road shape using a link showing a road and nodes connected by the link. The first map information 54 may include information such as a curvature of the road, a Point of Interest (POI), or the like. The route determined by the path determination part 53 is output to the MPU 60. In addition, the navigation device 50 may perform route guidance using the navigation HMI 52 on the basis of the route determined by the path determination part 53. Further, the navigation device 50 may be realized by a function of a terminal device such as a smart phone, a tablet terminal, or the like carried by, for example, a user. In addition, the navigation device 50 may transmit a current position and the destination to a navigation server via the communication device 20 and acquire a route returned from the navigation server.

The MPU 60 functions as, for example, a recommended lane determination part 61, and stores second map information 62 in a storage device such as an HDD, a flash memory, or the like. The recommended lane determination part 61 divides the route provided from the navigation device 50 into a plurality of blocks (for example, divides the route every 100 [m] in a vehicle traveling direction), and determines a recommended lane for each of the blocks with reference to the second map information 62. The recommended lane determination part 61 determines such as a number of a lane on which the vehicle travels counted from the left. The recommended lane determination part 61 determines a recommended lane such that the own vehicle M can travel on a reasonable traveling route to arrive at a branching destination when branching points, merging points, or the like are present on the route.

The second map information 62 is map information that is more precise than the first map information 54. The second map information 62 includes, for example, information of a center of the lane, information of a boundary of the lane, or the like. In addition, the second map information 62 may include road information, traffic regulation information, address information (address/zip code), facility information, telephone number information, and the like. The road information includes information that indicates types of road such as an expressway, a toll road, a national road, and a prefectural road, or information such as the number of lanes of the road, a width of each lane, a slope of the road, a position (three-dimensional coordinates including a longitude, a latitude and a height) of the road, a curvature of a curve of a lane, positions of merging and branching points of lanes, signs installed on the road, and the like. The second map information 62 may be updated at any time through access to another apparatus using the communication device 20.

The camera 70 in a passenger compartment is a digital camera using a solid-state image sensing device such as a CCD, a CMOS, or the like. The camera 70 in a passenger compartment is attached to a rearview mirror, a steering boss section or an installment panel, or another inner surface or the like of the passenger compartment, and can capture an image or a picture of an occupant's face or the like. For example, the camera 70 in a passenger compartment can capture an image or a picture of an occupant who sits on a passenger seat or an occupant who sits on a back seat, in addition to a driver.

The driving operator 80 includes, for example, an accelerator pedal, a brake pedal, a shift lever, a steering wheel, and the like. A sensor configured to detect an operation quantity or existence of an operation is attached to the driving operator 80, and the detection results thereof are output to the automated driving control unit 100, the driving force output apparatus 200, or one or both of the brake apparatus 210 and the steering apparatus 220.

The occupant holding apparatus 90 has, for example, a seat (not shown), a seat sensor 91, a seat belt 92, and a pretensioner 93. The seat sensor 91 is installed on each of a driver's seat, the passenger seat, and the back seat and detects whether an occupant sits thereon. That is, the seat sensor 91 detects the presence of an occupant on each of the seats. The pretensioner 93 is a device configured to pull the seat belt 92 and protect an occupant at a high level by removing slack of a belt (a webbing) of the seat belt 92, for example, when a collision of the own vehicle M occurs.

The automated driving control unit (the automated driving control part) 100 has, for example, a first controller 120, a second controller 140, an HMI controller 160, and a pretensioner controller 180.

Some or all of the first controller 120, the second controller 140, the HMI controller 160, and the pretensioner controller 180 are realized by a processor such as a Central Processing Unit (CPU) or the like executing a program (software). In addition, some or all of the first controller 120, the second controller 140, the HMI controller 160, and the pretensioner controller 180, which will be described below, may be realized by hardware such as a Large Scale Integration (LSI), an Application Specific Integrated Circuit (ASIC), a Field-Programmable Gate Array (FPGA), or the like, or may be realized by cooperation between software and hardware. Further, the HMI controller 160 and the pretensioner controller 180 will be described below.

The first controller 120 includes, for example, an external recognition part 121, an own vehicle position recognition part 122, and an action plan generating part 123.

The external recognition part 121 recognizes a state, such as a position, a speed, an acceleration, and the like, of a neighboring vehicle on the basis of information input from the camera 10, the radar device 12, and the finder 14 via the object recognition device 16. The position of the neighboring vehicle may be represented by a representative point such as a centroid, corners, or the like, of the neighboring vehicle, or may be represented by a region indicated by an outline of the neighboring vehicle. The “state” of a neighboring vehicle may include an acceleration or a jerk of the neighboring vehicle, or an “action state” (for example, whether a lane change is being performed or about to be performed). In addition, the external recognition part 121 may recognize positions of a guard rail, an electric pole, a parked vehicle, a person such as a pedestrian or the like, and other objects, in addition to the neighboring vehicle.

The own vehicle position recognition part 122 recognizes, for example, a lane on which the own vehicle M is traveling (a traveling lane) and a relative position and an attitude of the own vehicle M with respect to the traveling lane. The own vehicle position recognition part 122 recognizes the traveling lane by, for example, comparing a pattern of road lane markings obtained from the second map information 62 (for example, an arrangement of solid lines and broken lines) with a pattern of a road lane markings around the own vehicle M recognized from an image captured by the camera 10. The position of the own vehicle M acquired from the navigation device 50 or results of a process using an INS may be added to such recognition.

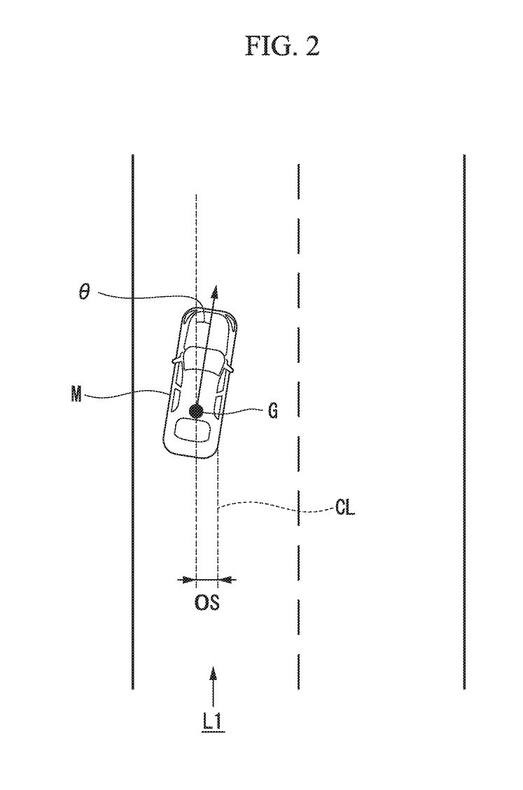

Then, the own vehicle position recognition part 122 recognizes, for example, a position or attitude of the own vehicle M with respect to a traveling lane. FIG. 2 is a view showing an aspect in which a relative position and attitude of the own vehicle M with respect to a traveling lane L1 are recognized by the own vehicle position recognition part 122. The own vehicle position recognition part 122 recognizes, for example, a divergence OS from a traveling lane center CL of a reference point G (for example, a center of gravity) of the own vehicle M and an angle θ with respect to a line continuing from the traveling lane center CL in a traveling direction of the own vehicle M as the relative position and attitude of the own vehicle M with respect to the traveling lane L1. Further, instead of this, the own vehicle position recognition part 122 may recognize a position or the like of a reference point of the own vehicle M with respect to any one of side end portions of the traveling lane L1 (owe vehicle lane) as the relative position of the own vehicle M with respect to the traveling lane. The relative position of the own vehicle M recognized by the own vehicle position recognition part 122 is provided to the recommended lane determination part 61 and the action plan generating part 123.

The action plan generating part 123 determines events that are sequentially executed in the automated driving such that the own vehicle M travels in the recommended lane determined by the recommended lane determination part 61 and deals with circumstances around the own vehicle M. The events include, for example, a constant speed traveling event in which the own vehicle M travels in the same traveling lane at a constant speed, an overtaking event in which the own vehicle M overtakes a preceding vehicle, a lane changing event, a merging event, a branching event, an emergency stop event, a handover event of terminating automated driving and switching automated driving to manual driving, and the like. In addition, an action for avoidance may be planned on the basis of the surrounding circumstances of the own vehicle M (the presence of neighboring vehicles or pedestrians and a lane narrowing or the like due to road construction) while these events are executed.

The action plan generating part 123 generates a target trajectory TT on which the own vehicle M will travel. The target trajectory TT is expressed by sequentially arranging points at which the own vehicle M will arrive (trajectory points TP). The trajectory points TP are points at which the own vehicle M will arrive by a predetermined traveling distance and, apart from that, a plurality of target speeds and target accelerations are generated as a part of the target trajectory TT at each of predetermined sampling time points (for example, every several tenths of a [sec]). In addition, the trajectory points TP may be positions at which the own vehicle M should arrive at the sampling time of each of the predetermined sampling times. In this case, information such as a target speed or a target acceleration is expressed at an interval of the trajectory points TP.

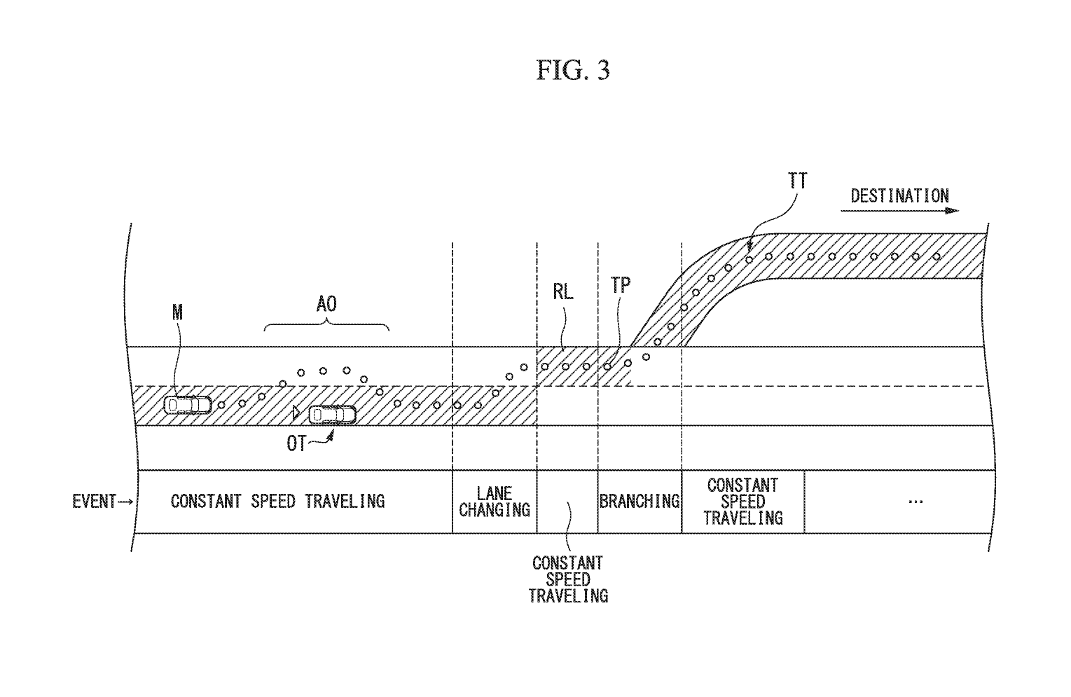

FIG. 3 is a view showing an aspect in which the target trajectory TT is generated on the basis of a recommended lane RL. As shown in FIG. 3, the recommended lane RL is set such that traveling to the destination along the route is convenient.

The action plan generating part 123 starts a lane changing event, a branching event, or a merging event when the own vehicle M reaches a predetermined distance before a switching point of the recommended lane RL (which may be determined according to the type of event). When it is necessary to avoid an obstacle OT (a stopped vehicle) while one of these events is executed, an avoidance trajectory AO is generated as shown in the drawing.

The action plan generating part 123 generates, for example, a plurality of candidates for the target trajectories and selects a most suitable target trajectory at that moment based on a viewpoint of safety and efficiency.

Returning back to FIG. 1 and describing FIG. 1, the second controller 140 includes a traveling controller 141. The traveling controller 141 controls the driving force output apparatus 200, the brake apparatus 210, and the steering apparatus 220 such that the own vehicle M passes along the target trajectory generated by the action plan generating part 123 at scheduled times.

According to the above-mentioned configuration, the automated driving control unit 100 realizes automated driving in which at least one of speed control and steering control of the own vehicle M is performed. For example, the automated driving control unit 100 realizes an automated driving mode in which both of the speed control and the steering control of the own vehicle M are performed.

The driving force output apparatus 200 outputs a traveling driving force (torque) for causing the vehicle to travel to driving wheels. The driving force output apparatus 200 includes, for example, a combination of an internal combustion engine, an electric motor, a gearbox, and the like, and an ECU configured to control them. The ECU controls the above-mentioned components according to information input from the traveling controller 141 or information input from the driving operator 80.

The brake apparatus 210 includes, for example, a brake caliper, a cylinder configured to transmit a hydraulic pressure to the brake caliper, an electric motor configured to generate the hydraulic pressure in the cylinder, and a brake ECU. The brake ECU is configured to control the electric motor according to the information input from the traveling controller 141 or the information input from the driving operator 80, and output a brake torque to the wheels according to a brake operation. The brake apparatus 210 may include a mechanism configured to transmit a hydraulic pressure generated by an operation of the brake pedal included in the driving operator 80 to the cylinder via a master cylinder as a back-up. Further, the brake apparatus 210 is not limited to the above-mentioned configurations, and may be an electronic control type hydraulic brake apparatus configured to control an actuator according to the information input from the traveling controller 141 and transmit a hydraulic pressure of the master cylinder to the cylinder.

The steering apparatus 220 includes, for example, a steering ECU and an electric motor.

The electric motor applies, for example, a force to a rack and pinion mechanism and changes a direction of the steered wheels. The steering ECU drives the electric motor and changes the direction of the steered wheels according to the information input from the traveling controller 141 and the information input from the driving operator 80.

Next, a function of the vehicle system 1 related to an encounter with an obstacle will be described in detail.

The vehicle system 1 of the embodiment is configured to further increase safety of an occupant in the own vehicle M when an obstacle separated from a road surface on which a collision may occur is detected in the surroundings of the own vehicle M.

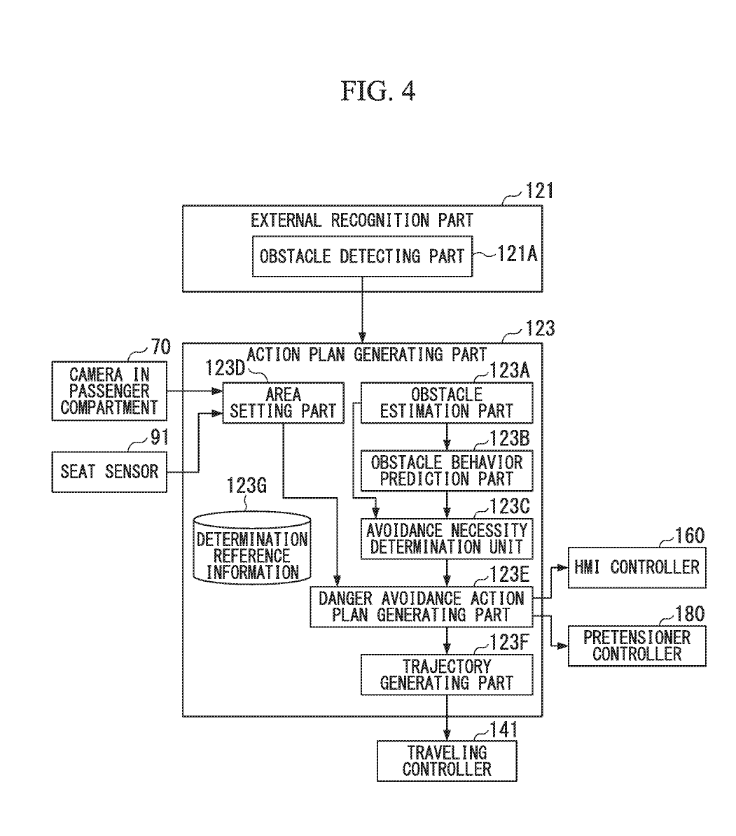

FIG. 4 is a configuration view showing a function of the vehicle system 1 related to an encounter with an obstacle. As shown in the drawing, the external recognition part 121 has an obstacle detecting part 121A.

The obstacle detecting part (the detector) 121A detects an obstacle present in a space around the vehicle and separated from a road surface. For example, the obstacle detecting part 121A detects an obstacle that is present in the space around the vehicle and may collide with the own vehicle M. The “obstacle” disclosed herein widely refers to a substance that interferes with normal traveling of the own vehicle M and may be an artificial substance or a natural substance. “Present in a space around the vehicle” is not limited to the case in which an obstacle is present in front of the own vehicle M, and also include the case in which an obstacle is present to the side, behind, or above the own vehicle M. “An obstacle separated from a road surface” includes, for example, an obstacle in a falling state (a falling object), an obstacle floating in space, a rising obstacle (for example, an obstacle rising from and bouncing on a road surface), or the like. In addition, the falling object is not limited to an object falling from above and also includes an object falling in a diagonally lateral direction or the like.

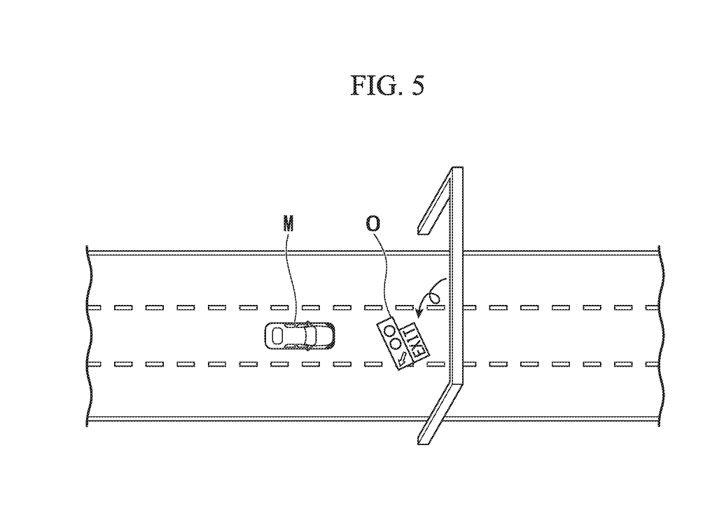

FIG. 5 is a view showing an example of a falling object O, which is an obstacle. The falling object O is an installed substance that is falling when the installed substance (signs, a sign board, or the like) installed on an upper structure such as a tunnel or a bridge is falling. In addition, another example of the obstacle is an object that is falling from a preceding vehicle or an object that has fallen and rebounded from a road surface (for example, an empty can or the like), an object that is falling from a sidewall of the road or an object that has fallen and rebounded from the road surface, an object blown by the wind (a vinyl bag, a magazine, or the like), an object flying in a space around the vehicle (drones, birds, or the like), and the like. However, the obstacle is not limited to the above-mentioned examples.

Returning again to FIG. 4 and describing FIG. 4, the obstacle detecting part 121A detects, for example, an obstacle present in a space around the own vehicle M on the basis of information input from the camera 10, the radar device 12, and the finder 14 via the object recognition device 16. For example, the obstacle detecting part 121A can detect an obstacle that is falling. In addition, the detected result of the obstacle detecting part 121A may include information related to a behavior of an obstacle (for example, information related to a speed vector of the obstacle) and the like. The obstacle detecting part 121A outputs the detected result of the obstacle detecting part 121A to the action plan generating part 123.

The action plan generating part 123 generates a danger avoidance action plan to further increase safety of an occupant in the own vehicle M on the basis of the detected result of the obstacle detecting part 121A. The action plan generating part 123 of the embodiment estimates at least one of a size and a type of an obstacle detected by the obstacle detecting part 121A, predicts a behavior of the obstacle on the basis of the estimated result of at least one of the size and the type of the obstacle, and generates a danger avoidance action plan of the vehicle on the basis of the predicted result of the behavior of the obstacle.

Further, the “danger avoidance action plan” may include at least one control instruction related to the own vehicle M.

In the embodiment, the action plan generating part 123 includes, for example, an obstacle estimation part 123A, an obstacle behavior prediction part 123B, an avoidance necessity determining part 123C, an area setting part 123D, a danger avoidance action plan generating part 123E, and a trajectory generating part 123F.

The obstacle estimation part 123A estimates at least one of the size and the type of the obstacle on the basis of the detected result of the obstacle detecting part 121A. The obstacle estimation part 123A estimates, for example, the size and the type of the obstacle. For example, the obstacle estimation part 123A estimates an actual size of the obstacle on the basis of information related to the size of the obstacle acquired through the camera 10 or the like and information related to a distance between the own vehicle M and the obstacle acquired through the radar device 12, the finder 14, or the like. For example, the obstacle estimation part 123A digitizes the size of the obstacle and recognizes the digitized size on the basis of a projection area or the like of the obstacle.

In addition, determination reference information 123G used as a reference of various types of determination is stored in a storage device (an HDD, a flash memory, or the like) of the vehicle system 1. In the determination reference information 123G, typical sizes, shapes, colors, or the like of various types of obstacles that may be present on a road and types of the obstacles are correspondingly managed. The obstacle estimation part 123A estimates the types of the obstacles by comparing the information related to at least one of the size, shape, color, or the like of the obstacle acquired through the camera 10 or the like with the information included in the determination reference information 123G. For example, the obstacle estimation part 123A estimates the type of the obstacle by selecting the closest type among a plurality of preregistered types such as a vinyl bag, a sign board, or the like. In addition, the obstacle estimation part 123A may estimate hardness or the like of the obstacle on the basis of the estimated kind of the obstacle. The obstacle estimation part 123A outputs the estimated result related to the obstacle to the obstacle behavior prediction part 123B and the avoidance necessity determining part 123C.

The obstacle behavior prediction part 123B estimates the behavior of the obstacle on the basis of the estimated result of at least one of the size and the type of the obstacle estimated by the obstacle estimation part 123A. For example, the obstacle behavior prediction part 123B predicts a behavior of the obstacle in the future time (for example, a position, a speed, an acceleration, or the like of the obstacle in the future time) on the basis of the information related to the size of the obstacle, the type of the obstacle, and the behavior of the obstacle included in the detected result of the obstacle detecting part 121A (for example, information related to a speed vector of the obstacle). For example, the obstacle behavior prediction part 123B estimates a weight of the obstacle on the basis of the size of the obstacle and the type of the obstacle and estimates the behavior of the obstacle (for example, a falling behavior) on the basis of an inertia system model (a free falling model due to gravity). Here, when the type of the obstacle estimated by the obstacle estimation part 123A corresponds to a preset type, the behavior of the obstacle may be predicted in consideration of a specific matter of each type. For example, when the obstacle is a type that can be easily affected by an influence of air resistance, for example, a vinyl bag, the obstacle behavior prediction part 123B may predict the behavior of the obstacle together with the influences of the size and the air resistance of the obstacle. In addition, the obstacle behavior prediction part 123B may estimate the behavior of the obstacle on the basis of a model different from the free falling model when the obstacle is a drone or a bird. The obstacle behavior prediction part 123B outputs the predicted result related to the behavior of the obstacle to the avoidance necessity determining part 123C.

The avoidance necessity determining part 123C determines, for example, whether it is necessary to avoid the obstacle on the basis of one of the size or the type of the obstacle estimated by the obstacle estimation part 123A. In the embodiment, the avoidance necessity determining part 123C determines whether it is the necessary to avoid the obstacle on the basis of both the size and the type of the obstacle estimated by the obstacle estimation part 123A. For example, the avoidance necessity determining part 123C determines that it is not necessary to avoid the obstacle when the size of the obstacle is equal to or less than a preset reference (threshold) and the type of the obstacle is a preset type. For example, the avoidance necessity determining part 123C determines that it is not necessary to avoid the obstacle when the obstacle is relatively small and the obstacle is a relatively flexible type. In a specific example, the avoidance necessity determining part 123C determines that it is not necessary to avoid the obstacle when the obstacle is a relatively small vinyl bag, an object corresponding thereto, or the like. Further, the avoidance necessity determining part 123C may determine that it is necessary to avoid the obstacle when the obstacle is relatively large (for example, when the obstacle is a relatively large vinyl bag) even if the obstacle is the relatively flexible type. Further, instead of this, the avoidance necessity determining part 123C may determine that it is necessary to avoid the obstacle on the basis of any one of the size and the type of the obstacle. For example, the avoidance necessity determining part 123C may determine that it is not necessary to avoid the obstacle when the size of the obstacle is equal to or less than the preset reference or when the type of the obstacle is a preset type.

In addition, the avoidance necessity determining part 123C determines that it is necessary to avoid the obstacle on the basis of a behavior of the obstacle predicted by the obstacle behavior prediction part 123B. For example, the avoidance necessity determining part 123C determines that the obstacle may come into contact with the own vehicle M on the basis of the behavior of the obstacle predicted by the obstacle behavior prediction part 123B. In the embodiment, the avoidance necessity determining part 123C determines the possibility that the obstacle may come into contact with the own vehicle M on the basis of the behavior of the obstacle predicted by the obstacle behavior prediction part 123B and an action plan of automated driving in progress in the own vehicle M being performed by the automated driving control unit 100 (for example, a position, a speed, an acceleration, or the like of the own vehicle M). Then, the avoidance necessity determining part 123C determines that it is not necessary to avoid the obstacle regardless of the size, the type, or the like of the obstacle when it is determined that the probability of contact between the obstacle and the own vehicle M is less than the threshold. On the other hand, the avoidance necessity determining part 123C determines that it is necessary to avoid the obstacle, for example, when the probability of contact between the obstacle and the own vehicle M is equal to or more than the threshold and the conditions related to the size or type of the obstacle is not satisfied in order to determine that the avoidance is unnecessary. Further, the avoidance necessity determining part 123C may determine the possibility that the obstacle may come into contact with the own vehicle M on the basis of the behavior of the obstacle predicted by the obstacle behavior prediction part 123B and information detected by the vehicle sensor 40 (a speed, an acceleration, an angular acceleration, an azimuth, or the like of the own vehicle M) instead of the above-mentioned information. Each of the “action plan of automated driving” and “information detected by the vehicle sensor 40” is an example of “information related to a future behavior of the own vehicle M.”

The avoidance necessity determining part 123C outputs a signal showing that it is necessary to avoid the obstacle when it is determined that it is necessary to avoid the obstacle by the avoidance necessity determining part 123C to the danger avoidance action plan generating part 123E. In addition, the avoidance necessity determining part 123C derives which portion of the own vehicle M will collide with the obstacle on the basis of the behavior of the obstacle predicted by the obstacle behavior prediction part 123B and information related to a behavior in the future of the own vehicle M. Then, the avoidance necessity determining part 123C outputs information showing which portion of the own vehicle M will collide with the obstacle, which is derived by the avoidance necessity determining part 123C, to the danger avoidance action plan generating part 123E.

Here, before describing the danger avoidance action plan generating part 123E, the area setting part 123D will be described. FIG. 6 is a plan view showing an example of area setting with respect to the own vehicle M by the area setting part 123D. The area setting part 123D sets at least a first portion (a first region) A1 and a second portion (a second region) A2 with respect to the own vehicle M. FIG. 6 shows an example in which the first portion A1 and the second portion A2 are set on the basis of strength (rigidity) of each part of the own vehicle M. The first portion A1 is an example of an “area previously set in the vehicle.” The second portion A2 is a portion in which a degree of influence when the obstacle comes into contact with the own vehicle M (for example, a degree of deformation of the vehicle when the obstacle comes into contact with the vehicle at the same speed and the same angle) is smaller than the first portion A1. In the embodiment, a roof portion of the own vehicle M is set as an example of the first portion A1. In addition, a bonnet portion of the own vehicle M is set as an example of the second portion A2.

Meanwhile, FIG. 7 is a plan view showing another example of area setting with respect to the own vehicle M by the area setting part 123D. FIG. 7 shows an example in which the first portion A1 and the second portion A2 are set on the basis of a riding condition of an occupant in the own vehicle M. In the example shown in FIG. 7, the case in which no occupant is in the passenger seat is shown. For example, the area setting part 123D determines that no occupant is on the passenger seat on the basis of information received from at least one of the camera 70 in a passenger compartment and the seat sensor 91. Then, the area setting part 123D sets a portion close to the driver's seat in a front section of the vehicle as the first portion A1 and sets a portion close to the passenger seat in the front section of the vehicle as the second portion A2 when no occupant is on the passenger seat. Further, instead of this, when no occupant is on the back seat, the portion in the vehicle corresponding to the driver's seat may be set as the first portion A1, and the portion in the vehicle corresponding to the rear seat may be set as the second portion A2. The area setting part 123D outputs the set results of the first portion A1 and the second portion A2 to the danger avoidance action plan generating part 123E.

Returning to FIG. 4 and describing FIG. 4, the danger avoidance action plan generating part 123E generates a danger avoidance action plan of the own vehicle M when it is determined that it is necessary to avoid the obstacle by the avoidance necessity determining part 123C. The danger avoidance action plan generating part 123E generates, for example, a danger avoidance action plan to avoid the obstacle (or reduce contact damage when contact with the obstacle cannot be avoided) on the basis of a behavior of the obstacle predicted by the obstacle behavior prediction part 123B and information detected by the vehicle sensor 40 (a speed, an acceleration, an angular speed, an azimuth, or the like of the own vehicle M). The danger avoidance action plan includes a control instruction related to at least one of an acceleration, a deceleration, and steering of the own vehicle M, a warning with respect to an occupant in the own vehicle M, and an operation of the pretensioner 93 of the seat belt 92. In the embodiment, the danger avoidance action plan generating part 123E generates a control instruction including at least one of an acceleration, a deceleration, and steering of the own vehicle M to avoid the obstacle, and outputs the control instruction to the trajectory generating part 123F. In addition, the danger avoidance action plan generating part 123E generates a control instruction to inform an occupant of a warning and outputs the control instruction to the HMI controller 160. Further, the danger avoidance action plan generating part 123E generates a control instruction to operate the pretensioner 93 and outputs the control instruction to the pretensioner controller 180.

In addition, the danger avoidance action plan generating part 123E determines whether the vehicle can avoid the obstacle by controlling at least one of the acceleration, the deceleration, and the steering of the own vehicle M on the basis of the behavior of the obstacle predicted by the obstacle behavior prediction part 123B and the information detected by the vehicle sensor 40 (the speed, the acceleration, the angular speed, the azimuth, and the like of the own vehicle M) when it is determined that it is necessary to avoid the obstacle. Then, the danger avoidance action plan generating part 123E generates a danger avoidance action plan to decrease contact damage on the basis of the behavior of the obstacle predicted by the obstacle behavior prediction part 123B and the information detected by the vehicle sensor 40 (the speed, the acceleration, the angular speed, the azimuth, and the like of the own vehicle M) when it is determined that the vehicle cannot avoid the obstacle. For example, the danger avoidance action plan generating part 123E generates a danger avoidance action plan in which contact between the obstacle and an area in the own vehicle M previously set (for example, a weakened portion) as a danger avoidance action plan is avoided to reduce the contact damage.

In the embodiment, the danger avoidance action plan generating part 123E generates a danger avoidance action plan in which the obstacle is brought into contact with the second portion A2 instead of the first portion A1 of the own vehicle M and outputs the danger avoidance action plan to the trajectory generating part 123F when it is determined that the obstacle cannot be avoided and the obstacle will collide with the first portion A1 of the own vehicle M. The danger avoidance action plan includes a control instruction of at least one of the acceleration, the deceleration, and the steering of the own vehicle M. As a specific example, the danger avoidance action plan generating part 123E generates a danger avoidance action plan for bringing the obstacle in contact with the bonnet portion by, for example, braking or the like when it is determined that the obstacle (for example, a falling object) will come into contact with the roof portion of the own vehicle M.

The trajectory generating part 123F performs generation of a trajectory for avoiding the obstacle (or reducing contact damage when contact with the obstacle cannot be avoided) on the basis of the danger avoidance action plan generated by the danger avoidance action plan generating part 123E. That is, the trajectory generating part 123F performs generation of a trajectory including at least one of the acceleration, the deceleration, and the steering. In addition, the trajectory generating part 123F performs generation of a trajectory by which contact with the obstacle is avoided in a preset area in the own vehicle M (for example, a weakened section) when it is determined that the vehicle cannot avoid the obstacle. In the embodiment, the trajectory generating part 123F performs generation of a trajectory including at least one of the acceleration, the deceleration, and the steering of the own vehicle M for bringing the obstacle into contact with the second portion A2 instead of the first portion A1 when it is determined that the obstacle will collide with the first portion A1 of the own vehicle M. A trajectory generating part 360 outputs the information related to the generated trajectory to the traveling controller 141.

The HMI controller 160 informs an occupant of an alarm by controlling the notification part 31 of the HMI 30 on the basis of the control instruction from the danger avoidance action plan generating part 123E. For example, the HMI controller 160 informs the occupant of the alarm through a sound or pictures by controlling the notification part 31 of the HMI 30.

The pretensioner controller 180 retracts the seat belt 92 and reduces deflection of the seat belt 92 by controlling the pretensioner 93 on the basis of the control instruction from the danger avoidance action plan generating part 123E.

Next, an example of a processing flow of the vehicle system 1 related to an encounter with an obstacle will be described.

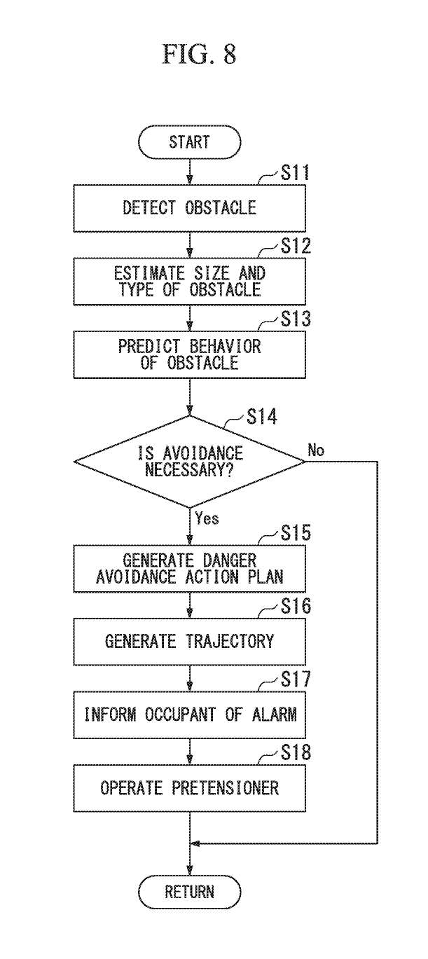

FIG. 8 is a flowchart showing an example of the processing flow of the vehicle system 1 related to an encounter with an obstacle. The obstacle detecting part 121A detects an obstacle when the own vehicle M encounters the obstacle present in a space around the own vehicle M and separated from a road surface (step S11). Next, the obstacle estimation part 123A estimates at least one of a size and type of the obstacle detected by the obstacle detecting part 121A (step S12). Next, the obstacle behavior prediction part 123B predicts a behavior of the obstacle on the basis of at least one of the size and the type of the obstacle estimated by the obstacle estimation part 123A (step S13).

Next, the avoidance necessity determining part 123C determines whether it is necessary to avoid the obstacle (step S14). For example, the avoidance necessity determining part 123C determines that it is not necessary to avoid the obstacle when it is determined that there is substantially no probability of collision between the obstacle and the own vehicle M on the basis of a behavior or the like of the obstacle predicted by the obstacle behavior prediction part 123B. In addition, the avoidance necessity determining part 123C determines that it is not necessary to avoid the obstacle when the size of the obstacle estimated by the obstacle estimation part 123A is equal to or less than a preset reference or the type of the obstacle estimated by the obstacle estimation part 123A is a preset type even if a collision between the obstacle and the own vehicle M may occur. On the other hand, the avoidance necessity determining part 123C determines that it is necessary to avoid the obstacle, for example, in any case except for the above-mentioned situation.

Next, the danger avoidance action plan generating part 123E generates a danger avoidance action plan including a control instruction related to at least one of an acceleration, a deceleration, and steering of the own vehicle M, a warning with respect to an occupant in the own vehicle M, and an operation of the pretensioner 93 when it is determined that it is necessary to avoid the obstacle by the avoidance necessity determining part 123C (step S15). The danger avoidance action plan generating part 123E outputs the control instruction included in the generated danger avoidance action plan to the trajectory generating part 123F, the HMI controller 160, and the pretensioner controller 180.

The trajectory generating part 123F performs generation of a trajectory including at least one of the acceleration, the deceleration, and the steering of the own vehicle M on the basis of the control instruction from the danger avoidance action plan generating part 123E (step S16). The trajectory generating part 123F outputs the generated trajectory to the traveling controller 141. In addition, the HMI controller 160 informs the occupant of the alarm by controlling the notification part 31 of the HMI 30 on the basis of the control instruction from the danger avoidance action plan generating part 123E (step S17). In addition, the pretensioner controller 180 retracts the seat belt 92 and reduces deflection of the seat belt 92 by controlling the pretensioner 93 on the basis of the control instruction from the danger avoidance action plan generating part 123E (step S18). Accordingly, a danger avoidance action of the own vehicle M is realized. Further, steps S16, S17 and S18 may be performed in any order or may be performed substantially at the same time.

According to the above-mentioned configuration, since the behavior of the obstacle is predicted on the basis of the estimated result of at least one of the size and the type of the obstacle and the danger avoidance action plan of the vehicle is generated on the basis of the predicted result of the behavior of the obstacle, the probability of contact between the obstacle and the own vehicle M can be more securely reduced. Accordingly, further improvement of safety can be achieved.

Hereinabove, while an aspect of performing the present invention has been described using the embodiment, the present invention is not limited to the above-mentioned embodiment, and various deformations and substitutions may be made without departing from the scope of the present invention.

For example, the obstacle estimation part 123A may estimate a shape of an obstacle instead of a size of the obstacle. Then, the obstacle behavior prediction part 123B may be predict a behavior of the obstacle on the basis of the shape of the obstacle estimated by the obstacle estimation part 123A. In addition, the avoidance necessity determining part 123C may determine whether it is necessary to avoid the obstacle on the basis of the shape of the obstacle estimated by the obstacle estimation part 123A. In other words, the “size of the obstacle” in the description of the above-mentioned embodiment may be substituted with the “shape of the obstacle.”

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle control system comprising:
a detector that detects an obstacle present in a space around a vehicle and separated from a road surface; and
an action plan generating part that estimates at least one of a size and a type of the obstacle detected by the detector, predicts a behavior of the obstacle on the basis of the estimated result, and generates a danger avoidance action plan of the vehicle on the basis of the predicted result of the behavior of the obstacle.

2. The vehicle control system according to claim 1,
wherein the danger avoidance action plan comprises a control instruction related to at least one of an acceleration, a deceleration, and steering of the vehicle, a warning with respect to an occupant in the vehicle, and an operation of a pretensioner of a seat belt of the vehicle.

3. The vehicle control system according to claim 1,
wherein the action plan generating part determines a necessity of obstacle avoidance on the basis of the predicted result of the behavior of the obstacle and information related to a future behavior of the vehicle, and generates the danger avoidance action plan when it is determined that the obstacle avoidance is necessary.

4. The vehicle control system according to claim 1,
wherein the action plan generating part determines a necessity of obstacle avoidance on the basis of the estimated result of at least one of the size and the type of the obstacle, and generates the danger avoidance action plan when it is determined that the obstacle avoidance is necessary.

5. The vehicle control system according to claim 4,
wherein the action plan generating part determines that the obstacle avoidance is not necessary when it is estimated that the type of the obstacle is a preset type.

6. The vehicle control system according to claim 1,
wherein the action plan generating part generates a danger avoidance action plan in order to avoid a contact between the obstacle and a preset portion of the vehicle when it is determined that a contact between the obstacle and the vehicle cannot be avoided on the basis of the predicted result of the behavior of the obstacle.

7. The vehicle control system according to claim 6,
wherein the vehicle comprises a first portion and a second portion, the second portion being a portion in which a degree of influence upon contact with the obstacle is smaller than the first portion, and
the action plan generating part generates a danger avoidance action plan that brings the second portion into contact with the obstacle instead of the first portion when it is determined that the obstacle will come into contact with the first portion on the basis of the predicted result of the behavior of the obstacle.

8. The vehicle control system according to claim 1,
wherein the detector is able to detect an obstacle that is falling, and
the action plan generating part predicts a falling behavior of the obstacle on the basis of the estimated result of at least one of the size and the type of the obstacle, and generates a danger avoidance action plan of the vehicle on the basis of the predicted result of the falling behavior of the obstacle.

9. A vehicle control system comprising:
a detector that detects an obstacle present in a space around a vehicle and separated from a road surface; and
an action plan generating part that estimates a type of the obstacle detected by the detector and determines a necessity of obstacle avoidance on the basis of the estimated result of the type of the obstacle.

10. A vehicle control method of allowing an onboard computer to:
detect an obstacle present in a space around a vehicle and separated from a road surface; and
estimate at least one of a size and a type of the obstacle, predict a behavior of the obstacle on the basis of the estimated result, and generate a danger avoidance action plan of the vehicle on the basis of the predicted result of the behavior of the obstacle.

11. A vehicle control program of allowing an onboard computer to:
detect an obstacle present in a space around a vehicle and separated from a road surface; and
estimate at least one of a size and a type of the obstacle, predict a behavior of the obstacle on the basis of the estimated result, and generate a danger avoidance action plan of the vehicle on the basis of the predicted result of the behavior of the obstacle.
